(19) United States
(12) Patent Application Publication
(10) Pub. No.: US 2021/0402981 A1
(43) Pub. Date: Dec. 30, 2021

(54) VIRTUAL VEHICLE INTERFACE

(71) Applicant: Micron Technology, Inc., Boise, ID (US)

(72) Inventor: Robert Richard Noel Bielby, Placerville, CA (US)

(21) Appl. No.: 16/916,799

(22) Filed: Jun. 30, 2020

(51) Int. Cl. B60W 30/00; G06F 9/451; B60W 10/04; B60W 10/18; B60W 10/20; B60W 50/10; B60W 40/08; B60W 60/00; G05D 1/00

(52) U.S. Cl. CPC B60W 30/00; G06F 9/451; B60W 10/04; B60W 10/18; B60W 10/20; B60W 2040/0809; B60W 40/08; B60W 60/0025; G05D 1/0044; G05D 1/0038; G05D 1/0016; B60W 50/10

(57) ABSTRACT

Various embodiments of the present disclosure are directed to virtual vehicle interface that allows a user to adjust a vehicle's drive settings to make the driving experience more customized. For example, a user may select a desired response time, sensitivity, handling, or other criteria through a user interface of a mobile device. When the mobile device is connected to the vehicle, the vehicle adopts the user's specified settings to provide a customized driving experience.

### BACKGROUND

Vehicles are driven by users who manipulate various components such as wheels, brake pedals, accelerator pedals. Some vehicles are capable for some degree of autonomous driving so that these components are computer controlled. In either case, a given vehicle's response time, handling, a configuration is generally the same regardless of who drives it.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of a networked environment according to various embodiments of the present disclosure.

FIG. 2 is a drawing of various components in a vehicle operating in the networked environment of FIG. 1 according to various embodiments of the present disclosure.

FIGS. 3-5 are flowcharts illustrating varying examples of the functionality of a vehicle implemented in in the networked environment of FIG. 1 according to various embodiments of the present disclosure.

FIG. 6 is a schematic block diagram that provides one example illustration of a vehicle computing system according to various embodiments of the present disclosure.

### DETAILED DESCRIPTION

Various embodiments of the present disclosure relate to customizing a vehicle's drive settings through a mobile device. Vehicles typically have components such as, for example, a steering wheel, an accelerator pedal, a brake pedal, and a gear stick. Each of these components are manually actuated by a user to control the vehicle. Such components affect the vehicle's responsiveness, handling, acceleration, or deceleration, thereby delivering a particular driving experience to the user. The present disclosure is directed to modifying vehicle settings to adjust this driving experience by making it customizable. For example, a user may select a desired response time, sensitivity, handling, or other criteria through a user interface of a mobile device. When the mobile device is connected to the vehicle, the vehicle adopts the user's specified settings to provide a customized driving experience.

The response time, degrees of responsiveness, handling, sensitivity, and other aspects of vehicle control may be compensated by a user interface generated by the mobile device so that different vehicles from different manufactures may have similar/personalized driving experience for the user (e.g., how aggressive acceleration/braking/steering is implemented). Different cars whether they are rented or borrowed may be driven in the same way as the favorite car of the user. The same car may be customized to be driven in different styles for different users.

According to other embodiments, a user may drive the vehicle in virtual reality or augmented reality mode such as, for example, through speed control by a virtual or real joystick, a set of virtual buttons for gear change, and accelerometers/gyroscopes of a mobile device as the steering wheel. The user may use some of the existing hardware of the vehicle but in a manner made customizable through a mobile device. For example, the gear stick input may be re-interpreted as joystick input. The use of the mobile device as it is connected to the vehicle may be manipulated by a user in a way the simulates a video game.

In additional embodiments, an autonomous driving system may monitor the road condition for the user and allow the user to control the vehicle within a range limited by safety calculations. The user may at least partially override an autonomous driving mode using a user interface generated by the mobile device. While the foregoing provides a high level summary, the details of the various embodiments may be understood with respect to the figures.

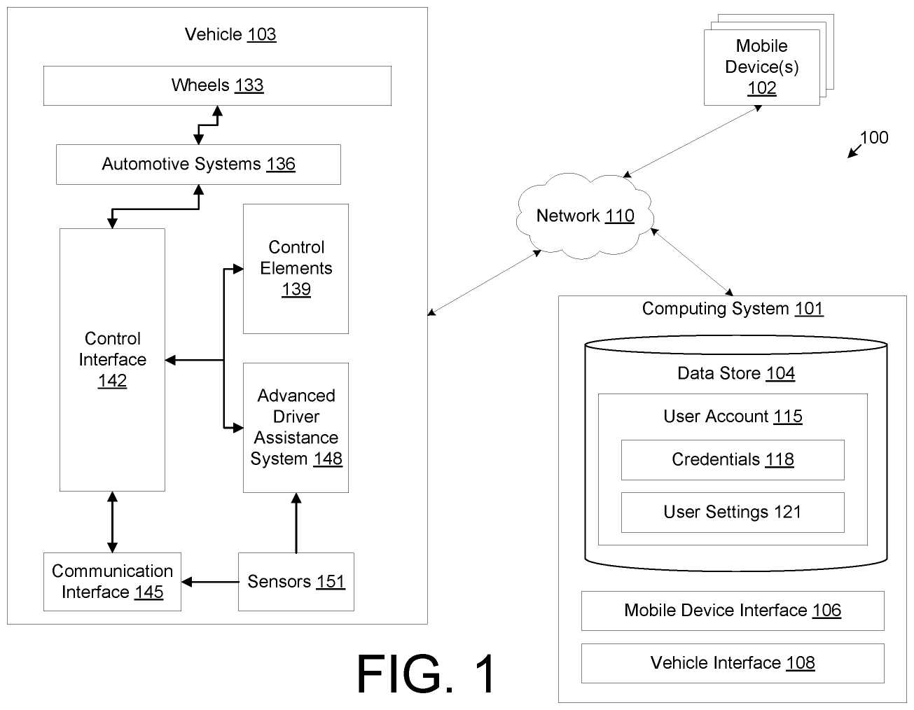

FIG. 1 shows a networked environment 100 according to various embodiments. The networked environment includes a computing system 101 that is made up of a combination of hardware and software. It further includes mobile devices 102 and vehicles 103.

The computing system 101 includes a data store 104, a mobile device interface 106, and a vehicle interface 108. The computing system 101 may be connected to a network 110 such as the Internet, intranets, extranets, wide area networks (WANs), local area networks (LANs), wired networks, wireless networks, or other suitable networks, etc., or any combination of two or more such networks. The network 110 may also comprise a peer-to-peer contention or shortrange wireless connection

The computing system 101 may comprise, for example, a server computer or any other system providing computing capability. Alternatively, the computing system 101 may employ a plurality of computing devices that may be arranged, for example, in one or more server banks or computer banks or other arrangements. Such computing devices may be located in a single installation or may be distributed among many different geographical locations. For example, the computing system 101 may include a plurality of computing devices that together may comprise a hosted computing resource, a grid computing resource and/or any other distributed computing arrangement. In some cases, the computing system 101 may correspond to an elastic computing resource where the allotted capacity of processing, network, storage, or other computing-related resources may vary over time. The computing system 101 may implement one or more virtual machines that use the resources of the computing system 101.

Various applications and/or other functionality may be executed in the computing system 101 according to various embodiments. Also, various data is stored in the data store 104 or other memory that is accessible to the computing system 101. The data store 104 may represent one or more data stores 104. This data includes, for example, user accounts 115. A user account 115 includes a user's credentials 118 which may be, for example, a user name, password, identification of the user's mobile device 102, and other information use to authenticate a user. The user account 115 may also include user settings 121 pertaining to how a user wishes to configure a vehicle. Thus, the user account 115 stores information about a user of a mobile device 102 to operate or configure a vehicle 103.

As mentioned above, the components executed on the computing system 101 may include a mobile device interface 106, and a vehicle interface 108, which may access the contents of the data store 103. The mobile device interface 106 establishes communication with a mobile device 102 and permits a mobile device to communicate with the computing system 101 over the network 110. The vehicle interface 108 establishes communication with a vehicle 103 and permits the vehicle 103 to communicate with the computing system 101 over the network 110. Together, the mobile device interface 106 and vehicle interface 108 allow the mobile device 102 and vehicle 103 to communicate with each other via the computing system 101. However, in some embodiments, the mobile device 102 and vehicle 103 may establish a peer-to-peer connection to directly communicate with each other.

The computing environment 100 also includes one or more mobile device(s) 102. A mobile device 102 allows a user to interact with the components of the computing system 101 over a network 110. A mobile device 102 may be, for example, a cell phone, laptop, or any other computing device used by a user. The mobile device 102 may include an application that communicates with the mobile device interface 106 or directly with the vehicle 103 to access, manipulate, edit, or otherwise view, control, operate or configure the vehicle 103. The mobile device 102 may include various components or peripherals for viewing vehicle data or controlling the vehicle 103. For example, it may include an accelerometer, gyroscope, display screen, haptic controller, joystick, touch screen, buttons, microphone, head mounted display, virtual reality peripherals, or camera. The mobile device 102 is configured to render a user interface for virtually operating, configuring, or viewing the real time driving environment of the vehicle 103.

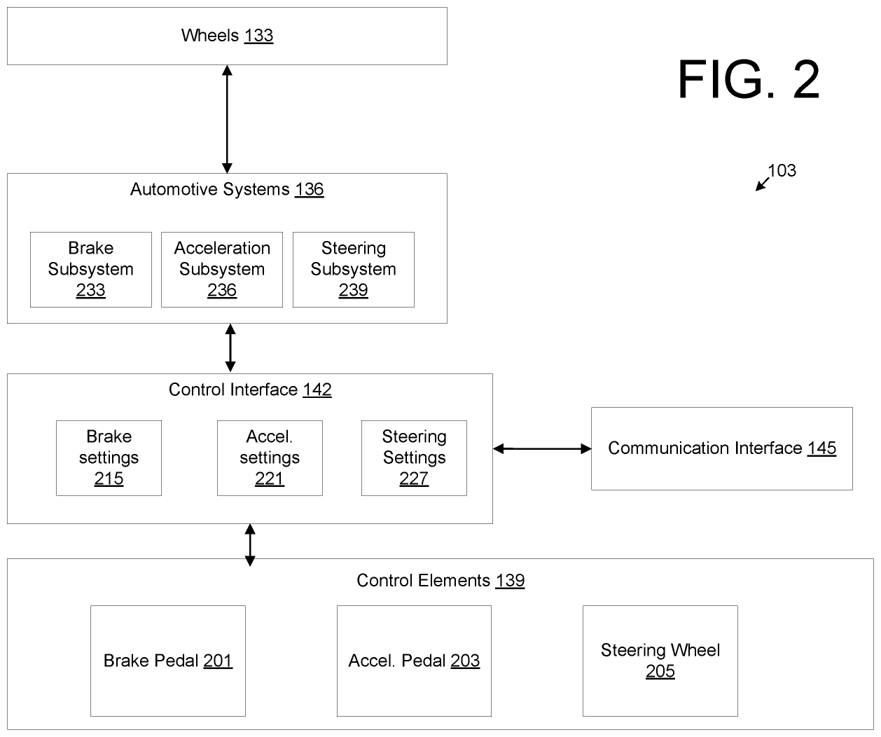

The vehicle 103 may be a car, truck, or other machine to transport individuals. The vehicle 103 includes wheels 133 that cause the vehicle 103 to move. The wheels are controlled by various automotive systems 136 of the vehicle. These automotive systems 136 include subsystems for causing driving the wheels, slowing the wheel rotation down, steering the wheels 133 to turn the vehicle 133, and other mechanical systems for operating the vehicle 103. The powertrain 136 is, in part, electromechanical such that it may receive control signals and convert them into mechanical output for causing the vehicle 103 to move. The automotive systems 136 are described in further detail with respect to FIG. 2.

The vehicle 103 further includes a control interface 142, which is coupled to the automotive systems 136. The control interface 142 may implemented by software and/or hardware. The control interface 142 receives user inputs, applies one or more functions, and generates corresponding control signals. The control signals are provided to the automotive systems 136 to operate the vehicle by controlling how the wheels move. In some embodiments, the automotive systems 136 provide feedback to the control interface 142 depending on how the vehicle is operated. For example, as a vehicle's wheel's 133 straighten out, the angle of the wheels 33 may be provided to the control interface 142.

The vehicle 103 includes various control elements 139, each of which are coupled to the control interface 142. A control elements 139 may include pedals, shifters, buttons, joysticks, and other structures controlling the automotive systems 136. Control elements 139 may receive manual input from a user and convert that into an electrical input supplied to the control interface 142. The control elements are described in further detail with respect to FIG. 2.

The vehicle 103 further includes a communication interface 145 that is coupled to the control interface 142. The communication interface 145 may include a radio transceiver or other hardware module configured to wirelessly communicate over the network 110. The communication interface 145 may receive data packets and other transmissions from the network 110, process them, and forward them to the control interface 142. The commination interface 145 may establish a connection with the mobile device 102. The connection may be direct with the mobile device 102 or through a computing device 101.

The vehicle 103 may also include an advanced driver assistance (ADA) system 148. The ADA system 148 may include functionality to carry out autonomous driving capability. This includes, for example, lane detection, distance calculations to nearby objects, virtual horizon calculations, video processing, object recognition, and other algorithms to permit autonomous or semi-autonomous driving. The vehicle 103 further includes sensors 151 such as, for example, video cameras, Radio Detection and Ranging (radar), Light Detection and Ranging (lidar), other electromagnetic sensors, and audio sensors. The sensors 151 generate sensor data that is provided to the ADA system 148. In some embodiments, the sensor data is provided to the communication interface 145 for transmission to a mobile device 102.

Next, a general description of the operation of the various components of the computing system 101 is provided. A vehicle 103 is driven as the automotive systems 136 cause the wheels 133 to accelerate, slow down, or turn. The automotive systems 136 are controlled by the control interface 142 that supplies control signals to the automotive systems 136. The control signals may, for example, instruct automotive systems 136 to cause the wheels 133 to accelerate, not accelerate, brake, and not brake, or to turn. In addition, the control signals may indicate the degree of acceleration or braking. The control signals may also specify a transmission gear or an angle to rotate the wheels 103, thereby turning the vehicle.

The control interface 142 may receive user input from the control elements 139 or from a mobile device 102 in communication with the vehicle 103 via the communication interface 145. When receiving user inputs via the control elements 139, a user manually actuates or manipulates the control elements 139 to operate the vehicle 103. These inputs are transformed by the control interface 142 into control signals and are then supplied to automotive systems 136. This process is described in greater detail with respect to FIG. 2.

When the control interface 142 receives inputs from a mobile device 102, the mobile device 102 first establishes communication with the vehicle 103. The vehicle 103 may first authenticate the user of the mobile device 102 using credentials 118. Then, the vehicle 102 may grant the user access to the control interface 142 so that the user may exhibit at least partial control over the vehicle 102. The user provides user inputs via the mobile device 102, where the user inputs are transmitted over the network 110 and received by the communication interface 145 of the vehicle 103. The communication interface 145 may decode and/or decrypt the communication received from the mobile device 102 to extract the user inputs and then forward them to the control interface 142.

In some embodiments, the mobile device 102 and vehicle 103 communicate indirectly via the computing system 101. In this embodiment, the functionality of the vehicle 102 and/or mobile device 102 may be implemented in a distributed environment where the computing system 101 performs some operations such as authentication, authorization, and the storage of user settings 121. In other embodiments, the mobile device 102 may communicate with vehicle 103 directly over a network 110 such as a peer-to-peer connection. For example, the mobile device 102 may pair with the vehicle and establish a secure connection. While FIG. 1 shows a computing system 101 being separate, it should be appreciated that at least some components in the computing system 101 may be implemented in the vehicle 103 and/or mobile device.

The ADA system 148 may automatically generate inputs that are passed through the control interface 142. The control interface 142 may receive inputs from the ADA system 148, form the control elements 139, and from the mobile devices 102 simultaneously or at different times. The control interface 142 is configured to prioritize or otherwise reconcile the user inputs before translating them into corresponding control signals.

FIG. 2 is a drawing of various components in a vehicle 103 operating in the networked environment 100 of FIG. 1 according to various embodiments of the present disclosure. FIG. 2 provides an example of various types of control elements 139 included in the vehicle 103. The control elements 139 may include a brake pedal 201, an acceleration pedal 203, a steering wheel 205, and potentially other control elements (e.g., a gear stick). Each control element 139 receives user input as the user actuates or otherwise manipulates the control element 139. Each control element 139 converts the received user input into an electrical signal that is provided into the control interface 142 as a user input.

The automotive systems 136 comprises a plurality of subsystems such as, for example, a brake subsystem 233, an acceleration subsystem 236, a steering subsystem 239, a drivetrain 242, and a motor/engine 245. The brake subsystem 233 may comprise a hydraulic brake system, a regenerative braking system, a kinetic braking system, an engine-based braking using a transmission, or a combination thereof. The brake subsystem may comprise brake pads that are applied to the wheels 133 to cause deceleration in the wheel rotation. The braking subsystem may include an anti-lock brake system to prevent brakes from locking under extreme braking conditions. The brake subsystem 233 may be controlled by a pedal such as, for example, a brake pedal 201.

The acceleration subsystem 236 comprises an engine or motor for causing the wheels 133 to rotate. powertrain 136 includes a motor or engine to force the wheels 136 to rotate. The acceleration subsystem 236 may comprise an internal combustion engine or electrical motor with zero emission. The acceleration subsystem 236 may also include a transmission configured to operate according to a single gear or a selected gear. The brake subsystem 233 may be controlled by a pedal such as, for example, an acceleration pedal 203. In some embodiments, the brake pedal 201 and acceleration pedal 203 form a single pedal to control both braking and acceleration.

The acceleration subsystem 236 comprises a drivetrain, and an engine/motor for causing the wheels 133 to rotate. The acceleration subsystem 236 may comprise an internal combustion engine or electrical motor with zero emission. The acceleration subsystem 236 may also include a transmission configured to operate according to a single gear or a selected gear. The acceleration subsystem 236 may be controlled by a pedal such as, for example, an acceleration pedal 203. In some embodiments, the brake pedal 201 and acceleration pedal 203 form a single pedal to control both braking and acceleration. In addition, the acceleration subsystem 236 may be controlled by a gear stick or other gear selector to control the gear of the transmission or mode of acceleration. For example, a gear selector may selective a transmission gear, place the vehicle in a neutral, a park, or a reverse mode.

The steering subsystem 239 comprises a power steering system, axles, steering column, a rack, one or more joints and other components that make up the vehicle chassis for causing the wheels to turn right and left. The steering subsystem 239 may be controlled by a control element such as a steering wheel 205.

The brake subsystem 233, acceleration subsystem 236, and steering subsystem 239 for subsystems that make up the automotive subsystems 136. These subsystems may share some components and may be integrated or part of the vehicle chassis.

Control elements 139 control the automotive systems 136 via the control interface 142. For example, a brake pedal 201 may be actuated by a user's foot. As the user presses down on the brake pedal 201, the brake pedal 201 converts the mechanical input provided by a user into an electrical signal that reflects the user input. This electrical signal is provided to the control interface 142. The control interface 142 transforms this user input into a control signal by applying a brake function to the user input. Thus, the brake function converts the mechanical actuation of the brake pedal 201 into a control signal for controlling the brake subsystem 233. If the brake function is exponential, then the harder the user presses the brake pedal 201, the greater force is applied to the brake pads of the wheels. The brake function may include an offset or delay to adjust the sensitivity of the brakes, thereby making it less responsive to small amounts of actuation. Or, the brake function may lead to highly responsive brakes that are sensitive to small amounts of pressure on the brake pedal 201.

The brake function is adjustable according to one or more brake settings 215. The brake settings 215 may comprise an offset or coeffect to an exponential brake function. The brake settings 215 may also be a selection of one predefined brake function among a plurality of predefined brake functions. For example, the control interface 142 may store three brake functions: low sensitivity, medium sensitivity, and high sensitivity. The brake setting 215 may be a selection for one of these brake functions. The brake settings 215 may also reflect when and the degree of which to apply anti-lock brakes.

Similarly, the acceleration pedal 203 may be actuated by a user's foot. As the user presses down on the acceleration pedal 203, the acceleration pedal 203 converts the mechanical input provided by a user into an electrical signal that reflects the user input. This electrical signal is provided to the control interface 142. The control interface 142 transforms this user input into a control signal by applying an acceleration function to the user input. The acceleration function converts the mechanical actuation of the acceleration pedal 203 into a control signal for controlling the acceleration subsystem 236. Like the brake function, the acceleration function may reflect varying levels of sensitivities or responsiveness to pedal actuation.

The acceleration function is adjustable according to one or more acceleration settings 221. The acceleration setting may comprise an offset or coeffect to an exponential acceleration function. The acceleration settings 221 may also be a selection of one predefined acceleration function among a plurality of predefined acceleration functions. For example, the control interface 142 may store three acceleration functions: low sensitivity, medium sensitivity, and high sensitivity. The acceleration setting 221 may be a selection for one of these acceleration functions.

The steering wheel 205 may be actuated by a user who turns the steering wheel 205 in different directions to steer the vehicle 103. As the user turns the steering wheel 205, the steering wheel 205 converts the mechanical input provided by the user into an electrical signal that reflects the user input. This electrical signal is provided to the control interface 142. The control interface 142 transforms this user input into a control signal by applying a steering function to the user input. The steering function converts the mechanical actuation of the steering wheel 205 into a control signal to control the steering subsystem 239.

The steering function is adjustable according to one or more steering settings 227. The steering setting 227 is used by the steering function to determine how to convert the manner in which the steering wheel 205 is turned into a control signal to turn the wheels 133. The steering settings 227 may also be a selection of one predefined steering function among a plurality of predefined steering functions. For example, the control interface 142 may store three steering functions: low sensitivity, medium sensitivity, and high sensitivity. The steering setting 221 may be a selection for one of these steering functions.

The control signals generated by the control interface 142 are inputted into various automotive systems 136 to control the vehicle 103. In some embodiments, as the vehicle 103 is driven, feedback from the vehicle 103 or automotive systems 136 are provided to the control interface 142. For example, feedback may comprise a signal corresponding to the wheels 133 straightening out from completing the turn, the brakes locking up, the speed limit being exceeded, the presence of a flat tire, or any other driving conditions that are sensed by the vehicle 103. As the control interface 142 receives the feedback, the control interface 142 may disregard or limit the user inputs received from the control elements 139. For example, if the speed limit is exceeded, the control interface 142 may apply a limiting function to the user input originating from the acceleration pedal so that acceleration is capped regardless of how much force is applied to the acceleration pedal 203.

In some embodiments, the feedback received from the control interface 142 is used to mechanically control the control elements. For example, as a turn is completing and the wheels 133 are re-aligning, a feedback signal is sent to the control interface 142. The control interface 142 actuates the steering wheel 205 to bring it to its default position.

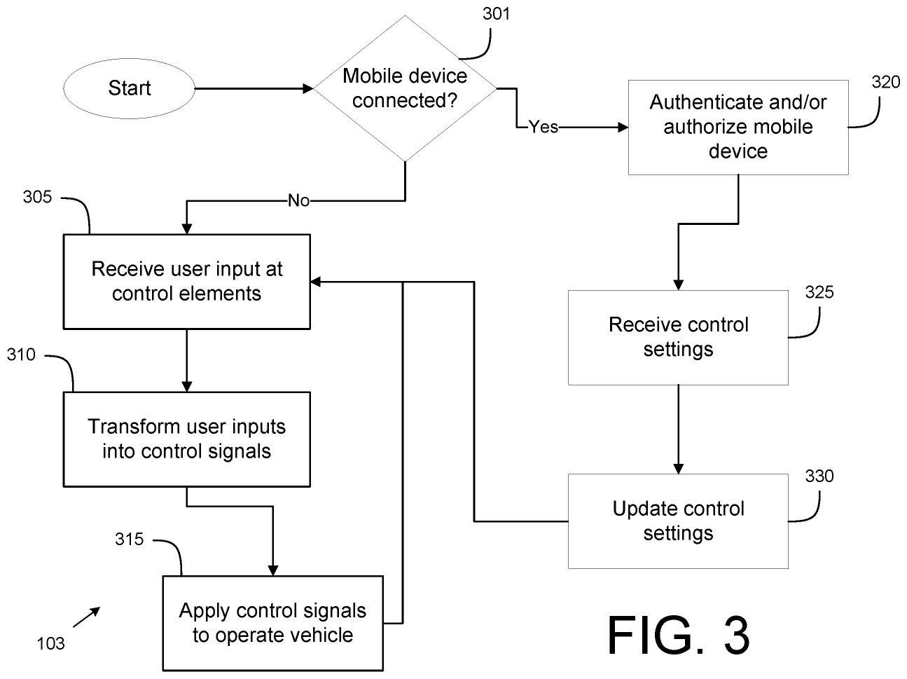

FIG. 3 is a flowchart illustrating an example of the functionality of the vehicle 103 implemented in a networked environment 100 of FIG. 1 according to various embodiments of the present disclosure. FIG. 3 provides an example of how a user can update a vehicle's control settings upon connecting the mobile device 102 to the vehicle 103. It is understood that the flowchart of FIG. 3 provides merely an example of the many different types of functional arrangements that may be employed to implement the operation of the vehicle 103 as described herein. The flowchart of FIG. 3 may be viewed as depicting an example of elements of a method implemented by the vehicle according to one or more embodiments.

At item 301 the vehicle 103 determines whether the mobile device 102 is connected. The communication interface 145 of the vehicle 103 may monitor for connection requests from the mobile device 102 or may periodically issue beacons to determine if the mobile device 102 is present. If no mobile device 102 is connected, the flowchart proceeds to item 305.

At item 305, the vehicle 103 receives user inputs at one or more control elements 139. For example, the user may actuate a brake pedal 201, acceleration pedal 203, steering wheel 205, gear stick, or any other control element 139. The control elements 139 translates these mechanical user inputs into user inputs that are electrical signals, which are then supplied to the control interface 142 for processing.

At item 310, the vehicle 103 transforms the user inputs into control signals. For example, the control interface 142 may first receive user inputs that are electrical signals from one or more control elements 139. Then, the control interface 142 may process these user inputs to transform them into control signals for accelerating, steering, braking, or otherwise controlling the vehicle 103. The transformation into control signal signals depends on different settings (e.g., brake settings, acceleration settings 221, and steering settings 227). These settings may be initially set to default settings. Thus, the transformation of the user inputs into control signals may be based on default functions defined by the default settings.

At item 315, the vehicle 103 applies the control signals to operate the vehicle 103. For example, the control signals are transmitted to automotive systems 136. The automotive systems 136 then apply any braking, steering, acceleration, or gear shifting functions as specified by the control signals received from the control interface 142.

Turning back to item 301, if a mobile device connection is detected 301, the flowchart proceeds to item 320. At item 320, the vehicle 103 authenticates and/or authorizes the mobile device 102. The vehicle 103 may employ a computing system 101 to authenticate and/or authorize the mobile device 102. The vehicle 102 may check the credentials 118 associated with the mobile device 102 to ensure it is trusted. The vehicle 102 may grant authorization to the mobile device 102 to access the vehicle 102 and its control interface 142. The vehicle 103 may provide authorization only if it determines that the mobile device 102 is within the vehicle or within a predefined distance from the vehicle 103. The vehicle 103 may include a proximity sensor or location module to track its relative or absolute location as well as the mobile device's 102 relative or absolute location.

At item 325, the vehicle 103 receives control settings. The mobile device 102 causes control settings to be transmitted to the vehicle 102. The mobile device 102 may directly transmit the control settings upon connection to the vehicle 103. Alternatively, the mobile device 102 may store the control settings in a computing system 101 as user settings 121. In this case, upon establishing a connection, the vehicle 103 may download the control settings from the user account 115 associated with the mobile device 102. The vehicle 103 may also have previously received the control settings from a prior communication session with the mobile device 102 and stored the user's settings locally in a vehicle's 103 memory.

At item 330, the vehicle 103 updates the control settings. For example, responsive to the mobile device 102 being connected to the vehicle 103 over the network 110, the vehicle 103 applies the received control settings (see item 325) as a brake setting 215, acceleration seeing 221, or steering setting 227. In this respect, the control interface 142 updates the control settings based on a connection with the mobile device 102. Once the control settings are updated, the flowchart proceeds to item 305. Here, the vehicle 103 continues to receive user inputs to control the vehicle. However, with the mobile device 102 connected, the user inputs are transformed according to a different functions based on the updated control settings. Thus, by connecting the mobile device 102 to the vehicle 103, a user can achieve a customized driving experience based on control settings directed to a particular level of sensitivity, responsiveness, handling, or control over the vehicle 103.

In some embodiments, the user's control settings may re-program or reconfigure a control element to operate in a customized way. For example, a gear stick may be reprogramed to operate as a different manner.

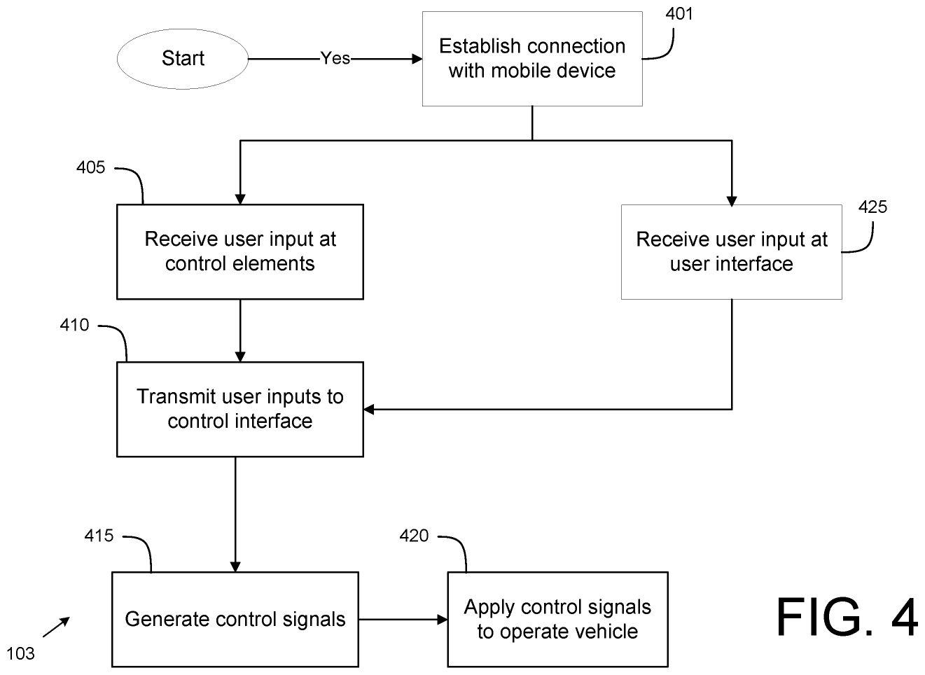

FIG. 4 is a flowchart illustrating an example of the functionality of the vehicle 103 implemented in a networked environment 100 of FIG. 1 according to various embodiments of the present disclosure. FIG. 4 provides an example of how a user can provide user input via a user interface of the mobile device 102 to control a vehicle 103. It is understood that the flowchart of FIG. 4 provides merely an example of the many different types of functional arrangements that may be employed to implement the operation of the vehicle 103 as described herein. The flowchart of FIG. 4 may be viewed as depicting an example of elements of a method implemented by the vehicle according to one or more embodiments.

At item 401, the vehicle 103 establishes a connection with a mobile device 102. These operations may be similar as described above with respect to item 301 and item 320. An established connection may include authentication and authorization for a mobile device 102 to access the control interface 142 of a vehicle 103.

At item 405, the vehicle 103 receives user inputs at control elements 139. For example, a user may actuate or manipulate a brake pedal 201, acceleration pedal 203, steering wheel 205, or other control elements 139 such as, for example, a gear stick, buttons, switches, or other pedals. As shown in FIG. 4, the user may essentially drive the vehicle 103 regardless of whether the mobile device 102 is connected to the vehicle 103.

At item 410, the user inputs are transmitted to the control interface 142. Each control element 139 may convert the manual actuation or manipulation of a control element 139 into a corresponding electrical user input that is supplied to the control interface 142. Thus, the control interface 142 may receive multiple user inputs simultaneously from corresponding control elements 139.

At item 415, the vehicle 103 generates control signals. The control interface 142 of the vehicle 103 may generate the control signals from the user inputs. Here, the control interface 142 applies various functions to the user inputs to transform them into corresponding control signals. The functions are defined by default control settings 215, 221, 227 or control settings 215, 221, 227 specified by a user.

At item 420, the vehicle 103 applies the control signals to operate the vehicle 103. For example, the control settings are inputted into the automotive systems 136 to control the vehicle's braking, acceleration, steering, gear selection, or other aspects of the vehicle's operation. Accordingly, the automotive systems 136 operate the vehicle 103 based on the received control signals.

At item 425, when the mobile device 102 is connected to the vehicle 103, the vehicle 103 may receive user inputs at a user interface generated by the mobile device 102. The user interface may be configured to receive user inputs via voice recognition. For example, the user may vocally provide user inputs to brake, accelerate, steer, or shift gears of the vehicle 103.

In some embodiments, the user interface may be configured to receive these user inputs via gesture recognition. In this example, the user interface may include a handheld controller configured to generate gesture input. Gesture input may be provided as part of an augmented reality or virtual reality system. The handheld controller may be a peripheral device connected to the mobile device 102 to provide user input. The handheld controller may include a directional pad, joy stick, touch screen, or motion sensors for determining gestures or hand motions. The hand motions or controller selections may correspond to particular controls to be applied to the vehicle 103.

In some embodiments, the user interface includes an augmented reality or virtual reality that presents a vitalized control element. In this respect, the physical brake pedal 201, acceleration pedal 203, steering wheel 205, or other control element 139 may be virtually represented as a 2D or 3D graphic that is rendered by the user interface of the mobile device 103. The mobile device 102 may include a head mounted display or glasses to render the user interface. The head mounted display may augment graphical representations of virtualized control elements over a live camera feed to provide augmented reality to a user who wishes to manipulate the vehicle 102.

Referring back to item 410, the user input received via the user interface of the mobile device 102 is transmitted to the control interface 142. Thus, the control interface 142 may receive user input from multiple sources including the control elements 139 and the mobile device 102. The control interface 142 may employ conflict resolution when it receives conflicting user inputs. One non-limiting example of conflicting user inputs includes receiving a user input to accelerate the vehicle 102 and receiving a user input to apply the vehicle's brakes. Another example of a conflict may occur when the steering wheel 205 corresponds to a left turn, but a gesture or handheld controller input received at the mobile device 103 corresponds to a right turn.

Some embodiments of conflict resolution include a control interface 102 that prioritizes the user inputs from one source over another or prioritize types of user inputs over other types of user inputs. For example, a user input for braking may supersede any other type of user input regardless of the source. As another example, user inputs received at the vehicle's control elements 139 may supersede user inputs received at the user interface of the mobile device 102.

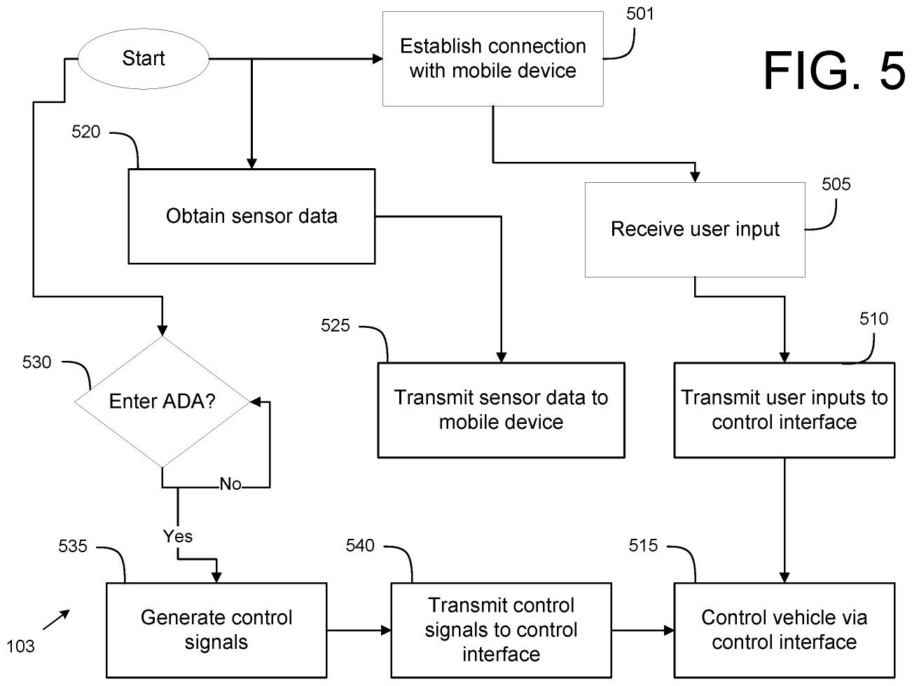

FIG. 5 is a flowchart illustrating an example of the functionality of the vehicle 103 implemented in a networked environment 100 of FIG. 1 according to various embodiments of the present disclosure. FIG. 4 provides an example of how user input is received in a vehicle 103 that includes an ADA system 148. It is understood that the flowchart of FIG. 5 provides merely an example of the many different types of functional arrangements that may be employed to implement the operation of the vehicle 103 as described herein. The flowchart of FIG. 5 may be viewed as depicting an example of elements of a method implemented by the vehicle according to one or more embodiments.

At item 501, the vehicle 103 establishes a connection with a mobile device 102. These operations may be similar as described above with respect to item 401. At item 505, the vehicle 103 receives user input. As described above with respect to items 405 and 425 of FIG. 4, user inputs may be received by control elements 139 or via a user interface rendered by a mobile device 102. At item 510, the vehicle 103 transmits user inputs to the control interface 142. These operations may be similar as above described with respect to item 410. At item 515, the vehicle 103 controls the vehicle 103 via the control interface 142. These operations may be similar as described above with respect to items 415 and 420.

Referring to item 520, while the vehicle 103 is controlled via the control interface 142, the vehicle 103 obtains sensor data. Sensor data is generated by the sensors 151 of the vehicle 103. This may include live video, radar, lidar, or audio signals pertaining to the vehicle's environment, road conditions, and nearby objects.

At item 525, the vehicle 103 transmits sensor data to the mobile device 102. The real time driving environment may be presented to the user via the user interface. According to embodiments, the mobile device 102 receives the sensor data and generates a graphical representation of the sensor data on the user interface. For example, the user interface may display virtualized representations of nearby objects. The user interface may generate a top down view of the vehicle including nearby objects. This can assist a user in navigating the vehicle 103 via the user interface to avoid nearby objects. The sensor data may also be used to calculate the relative or absolute velocities of nearby vehicles as the vehicle 103 shares the road with other drivers. Graphical representations of these velocities may be presented by the user interface to assist the operation of the vehicle 103.

At item 530, the vehicle 103 may wait for an instruction to enter an ADA mode. A user may select an ADA mode via a control panel located in the vehicle 103 or via a user interface on the mobile device 102. Upon receiving an instruction to enter ADA mode, the vehicle initiates the ADA system 148 to perform a degree of autonomous driving.

At item 535, the ADA system 148 generates control signals. The ADA system 148 uses the sensor data to generate control signals for driving the vehicle 103. The control signals include, for example, signals to cause the vehicle to accelerate, brake, steer, or shift gears.

At item 540, the vehicle 103 transmits the control signals generated by the ADA system 148 to the control interface 142. Thus, the control interface 142 may simultaneously receive control signals from the ADA system 148, user inputs from control elements 139, and user inputs originating by the mobile device 102 via a user interface. The control interface 142 may perform conflict resolution to account for the ability to control the vehicle through multiple systems.

In some embodiments, the ADA system is configured to monitor the safety of the operated vehicle according to control signals generated by the user inputs. In this respect, the ADA system 148 may limit or override user inputs received by the control interface 142. For example, the ADA system 148 may operate according to one or more predetermined safety rules. Safety rules may be, for example, a maximum speed for a given road, a minimum speed for a given road, or a minimum distance between nearby objects. In this respect, the ADA system 148 defines the guiderails or zones of control for how a vehicle 103 may be driven. The control interface 142 may generate further control signals according to the predetermined safety rules.

For example, the ADA system 148 may generate control signals so that the vehicle 103 maintains a speed of 50 miles per hour on a particular road. Based on the predetermined safety rules, a user may cause the vehicle to slow down or speed up by no more than 10 miles an hour. Thus, the user may provide user inputs via a control element 139 or via a user interface of the mobile device 102 to the extent that it does not violate the predetermined safety conditions. The control interface 142 applies the safety rules to resolve the control signals received from the ADA system 148 with user inputs to operate the vehicle 103. Referring back to item 515, the vehicle 103 is controlled via the control interface 142 based on receiving control signals from the ADA system 148 as well as user inputs.

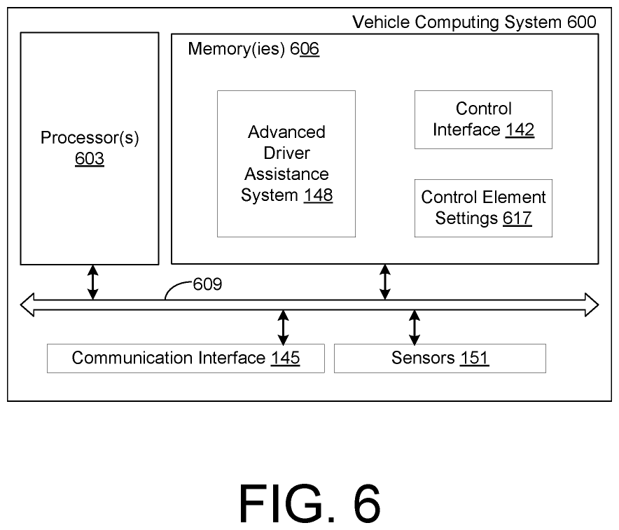

FIG. 6 is a schematic block diagram that provides one example illustration of a vehicle computing system 600 according to various embodiments of the present disclosure. The vehicle computing system 600 may include one or more computing devices used to implement the computing functionality of a vehicle 103 in the networked environment 100 of FIG. 1. The vehicle computing system 600 includes at least one processor circuit, for example, having a processor 603 and memory 606, both of which are coupled to a local interface 609 or bus. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 403 is the software application control interface 149 and ADA system 148. Also stored in the memory 406 may include the data stored in the data store 104. In addition, the memory 606 may store control element settings 617 which may be, for example, brake settings 215, acceleration settings 221, and/or steering settings 227. As discussed above, these control element settings 617 may be default settings that apply when a mobile device 102 is not connected to the vehicle 103 and may include user settings 121 that are applied when the mobile device 102 is connected to the vehicle 103.

It is understood that there may be other applications that are stored in the memory 606 and are executable by the processor 603 as can be appreciated. Where any component discussed herein is implemented in the form of software, any one of a number of programming languages may be employed, such as, for example, C, C++, C#, Objective C, Java®, JavaScript®, Perl, PHP, Visual Basic®, Python®, Ruby, or other programming languages.

Several software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 6406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 6406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may couple to additional systems such as the communication interface 145 to coordinate communication with remote systems.

Although components described herein may be embodied in software or code executed by hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc.

The flowcharts discussed above show the functionality and operation of an implementation of components within a vehicle 103. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system, such as a processor 603 in a computer system or other system. The machine code may be converted from the source code, etc. If embodied in hardware, each block may represent a circuit or a number of interconnected circuits to implement the specified logical function(s).

Although the flowcharts show a specific order of execution, it is understood that the order of execution may differ from that which is depicted. For example, the order of execution of two or more boxes may be scrambled relative to the order shown. Also, two or more boxes shown in succession may be executed concurrently or with partial concurrence. Further, in some embodiments, one or more of the boxes may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The components carrying out the operations of the flowcharts may also comprise software or code that can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including software application 106, may be implemented and structured in a variety of ways. For example, one or more applications described may be implemented as modules or components of a single application. Further, one or more applications described herein may be executed in shared or separate computing devices or a combination thereof. Additionally, it is understood that terms such as “application,” “service,” “system,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a control interface configured to be installed in a vehicle, the control interface having a plurality of control elements configured to receive first user input data; and
a communication interface coupled to the control interface and configured to communicate with a mobile device;
wherein, when the mobile device is not connected to the communication interface, the control interface is configured to control at least one of an acceleration subsystem of the vehicle, a brake subsystem of the vehicle, or a steering subsystem of the vehicle by transforming the first user input data according to first functions into control signals applied to accelerate, brake or steer the vehicle; and
wherein, when the mobile device is connected to the communication interface, the control interface is configured to transform the first user input data according to second functions into control signals of the vehicle.

2. The system of claim 1, wherein the control interface is configured to receive user settings for the second functions are transmitted by the mobile device interface through the communication interface.

3. The system of claim 2, wherein the mobile device is configured to provide a user interface to receive second user inputs; and wherein the vehicle is configured to transform the second user inputs into control signals to steer, brake, or accelerate the vehicle.

4. The system of claim 3, wherein the user interface is configured to receive the second user inputs via voice recognition.

5. The system of claim 3, wherein the user interface is configured to receive the second user inputs via gesture recognition.

6. The system of claim 5, wherein the user interface includes a handheld controller configured to transmit gesture input data in an augmented reality or virtual reality.

7. The system of claim 5, wherein the user interface includes an augmented reality or virtual reality that presents a vitalized control element of the vehicle via a head mounted display or glasses.

8. The system of claim 7, further comprising:
an advanced driver assistance system having sensors configured to monitor an environment of the vehicle, the advanced driver assistance system capable of driving the vehicle in an autonomous mode.

9. The system of claim 8, wherein the augmented reality or virtual reality includes presentation of the environment captured by the sensors of the advanced driver assistance system.

10. The system of claim 9, wherein the advanced driver assistance system is configured to monitor safety of the vehicle operated according to control signals transmitted according to user inputs and transmit further control signals according to predetermined safety rules.

11. The system of claim 1, wherein the plurality of control elements includes at least one of a steering wheel, an accelerator pedal, a brake pedal, or a gear stick.

12. A system, comprising:
a processor of a vehicle;
a communication interface; and
a memory coupled to a processor, the memory comprising a plurality of instructions which, when executed, cause the processor to:
receive, by a control interface, a plurality of first user input data from a plurality of control elements;
establish a connection, by the communication interface, with a mobile device;
control, when the mobile device is not connected to the communication interface, at least one of steering, braking or accelerating of the vehicle by transforming the first user input data according to first functions into control signals applied to steer, brake or accelerate the vehicle; and
transform, when the mobile device is connected to the communication interface, the first user input data according to second functions into control signals of the vehicle.

13. The system of claim 12, wherein user settings for the second functions are transmitted by the mobile device to the control interface through the communication interface.

14. The system of claim 12, wherein the mobile device is configured to provide a user interface to receive second user inputs; and wherein the vehicle is configured to transform the second user inputs into control signals to steer, brake, or accelerate the vehicle.

15. The system of claim 14, wherein the user interface is configured to receive the second user inputs via voice recognition.

16. The system of claim 14, wherein the user interface is configured to receive the second user inputs via gesture recognition.

17. The system of claim 16, wherein the user interface includes a handheld controller configured to transmit gesture input data in an augmented reality or virtual reality.

18. The system of claim 16, wherein the user interface includes an augmented reality or virtual reality that presents a vitalized control element of the vehicle via a head mounted display or glasses.

19. The system of claim 18, further comprising:
an advanced driver assistance system having sensors configured to monitor an environment of the vehicle, the advanced driver assistance system capable of driving the vehicle in an autonomous mode.

20. The system of claim 19, wherein the augmented reality or virtual reality includes presentation of the environment captured by the sensors of the advanced driver assistance system.

21. A method, comprising:
receiving, by a control interface, a plurality of first user input data from a plurality of control elements;
controlling, when the mobile device is not connected to a communication interface, at least one of steering, braking or accelerating of a vehicle by transforming the first user input data according to first functions into control signals applied to steer, brake or accelerate the vehicle;
transforming, in response to a connection being established between the communication interface and the mobile device, the first user input data according to second functions into control signals of the vehicle.

22. The method of claim 21, further comprising:
receiving, by the control interface through the communication interface, user settings for the second functions.

23. The method of claim 21, wherein the mobile device is configured to provide a user interface to receive second user inputs; and wherein the vehicle is configured to transform the second user inputs into control signals to steer, brake, or accelerate the vehicle.

24. The method of claim 23, wherein the user interface is configured to receive the second user inputs via at least one of voice recognition or gesture recognition.
